(19) United States
(12) Patent Application Publication
(10) Pub. No.: US 2024/0209159 A1
(43) Pub. Date: Jun. 27, 2024

(54) IMPROVEMENTS IN BIOMASS DELIGNIFICATION

(71) Applicant: SixRing Inc., Calgary (CA)

(72) Inventors: Alejandra ENRIQUEZ, Calgary (CA); Matthew DEWIT, Calgary (CA); Kyle G. WYNNYK, Calgary (CA); Markus WEISSENBERGER, Calgary (CA)

(21) Appl. No.: 18/392,952

(22) Filed: Dec. 21, 2023

(30) Foreign Application Priority Data
Dec. 22, 2022 (CA) 3184551

(51) Int. Cl. C08H 8/00; C08H 7/00

(52) U.S. Cl. CPC C08H 8/00; C08H 6/00

(57) ABSTRACT

A method for removing the constituents of a biomass into separate streams, where said method comprises the following steps:
Step 1: providing a biomass feedstock comprising: cellulose; hemicellulose; and lignin;
Step 2: exposing said biomass to a first acidic composition comprising an acid selected from the group consisting of: mineral acids; organic acids; modified acids; synthetic acids; and combinations thereof; for a first period of time sufficient to dissolve at least 50% of the hemicellulose present in said biomass;
Step 3: separating and recovering into a first liquid stream, the dissolved hemicellulose from the remaining biomass;
Step 4: exposing the remaining biomass mixture to a modified Caro's acid selected from the group consisting of:
   composition A; composition B and Composition C;
   wherein said composition A comprises:
      sulfuric acid in an amount ranging from 20 to 70 wt % of the total weight of the composition;
      a compound comprising an amine moiety and a sulfonic acid moiety selected from the group consisting of: taurine; taurine derivatives; and taurine-related compounds; and
      a peroxide;
   wherein said composition B comprises:
      an alkylsulfonic acid; and
      a peroxide; wherein the acid is present in an amount ranging from 40 to 80 wt % of the total weight of the composition and where the peroxide is present in an amount ranging from 10 to 40 wt % of the total weight of the composition;
   wherein said composition C comprises:
      sulfuric acid;
      a compound comprising an amine moiety;
      a compound comprising a sulfonic acid moiety; and
      a peroxide;
   for a first period of time sufficient to dissolve enough of the lignin present in said remaining biomass mixture to obtain a kappa number for the cellulose of less than 5;
   for a first period of time sufficient to dissolve enough of the lignin present in said remaining biomass mixture to obtain a kappa number for the cellulose of less than 5;
Step 5: recovering into a second liquid stream the dissolved lignin from the resulting reaction mixture, wherein said solid portion comprises cellulose fibers with, at most, 7.5 wt % hemicellulose.

### FIELD OF THE INVENTION

The present invention is directed to a method to separate lignocellulosic biomass into its three main constituents more effectively; more specifically, the method comprises a two-step approach to separate hemicellulose, lignin, and cellulose from one another.

### BACKGROUND OF THE INVENTION

Biofuel is increasingly becoming a necessity in order to wean off the human consumption of fossil fuels in aspects of everyday life, transport and home heating being the largest two industries of focus. As an alternative energy source to oil and coal, the main feedstock for biofuel production is starch, which can yield its sugar much more readily than cellulose. This is due to the difference in structure as starch links glucose molecules together through alpha-1,4 linkages and cellulose links glucose with beta-1,4 linkages. The beta-1,4 linkages allow for crystallization of the cellulose, leading to a more rigid structure which is more difficult to break down.

The limitation that comes from solely using the sugars from starches for the production of biofuels such as bioethanol prevents the utilization of the larger portion of biomass, which comes in the form of lignocellulosic biomass (contains lignin, cellulose and hemicellulose) present in almost every plant on earth. A delignification reaction allows the recovery of cellulose from those lignocellulosic plants. Once the cellulose is separated from the other two biomass constituents i.e., lignin, and hemicellulose, further degradation of the cellulose generates cellobiose and/or glucose, which can be further processed to bio-ethanol.

The extraction of hemicellulose from lignocellulosic biomass has been studied under various conditions: acid hydrolysis; alkaline extraction; peroxide extraction; vapor treatment; microwave treatment; ionic liquid extraction, and so on. The most commonly used method, acid hydrolysis, uses either a dilute concentration of acid (0.5%-1% sulfuric acid or hydrochloric acid) at high temperatures or a more concentrated acid at lower temperatures to break down hemicellulose to low molecular weight product. Both low-temperature hydrolysis and high temperature hydrolysis come with advantages and drawbacks. High-temperature extraction at a temperature of 150° C. to 170° C. provided high sugar yields and less degradation product. Moreover, due to the presence of acetate group in hemicellulose, under high temperature extraction, the presence of hydrogen ion in solution increases, which in turn accelerates the hydrolysis reaction, this is referred to as auto-hydrolysis.

When the ultimate goal of the treatment of the lignocellulosic biomass is to obtain bioethanol or other fermentation products, it is preferable to employ the dilute acid hydrolysis of hemicellulose to minimize the formation of decomposition products that are detrimental or toxic to microorganisms. Two-stage pre-treatment of wood chips have been found to maximize hemicellulose recovery in a first step and a subsequent stage of exposing the water-insoluble solids obtained from the first-stage prehydrolysate to dilute sulfuric acid allowed to hydrolyze a portion of the remaining cellulose to glucose to improve the enzyme digestibility. The total sugar yields obtained after enzymatic hydrolysis was found to be about 10% higher and reduced the net enzyme requirement about 50%.

Seen as a sustainable alternative to gasoline and with the goal of alleviating many countries' dependence on foreign oil, the biofuel industry is still hampered by its dependence on corn or sugar cane as their primary sources of bioethanol and subsequently fuel, as they are both rich in starch. It is estimated that about a third of all corn production in the U.S. is directed to the ethanol fuel production. This is a situation which has disastrous consequences when the prices of gasoline goes so low as to make corn-based biofuel unsustainable on a price view point.

To pivot from starches to cellulose for the production of glucose is preferable as it will provide near-unlimited amount of feedstock from waste biomass and reduce the competition with food source feedstock to generate glucose. However, the costs to do so are currently prohibitive. Cellulosic ethanol, as it is called, relies on the non-food part of a plant to be used to generate ethanol. This would allow the replacement of the current more widespread approach of making bioethanol by using corn or sugarcane. The diversity and abundance of these types of cellulose-rich plants would allow to maintain food resources mostly intact and capitalize on the waste generated from these food resources (such as cornstalk) to generate ethanol. Other cellulose sources such as grasses, algae and even trees fall under the cellulose-rich biomass, which can be used in generating ethanol if a commercially viable process is developed.

The hydrolysis of cellulose is, as seen from the above, limited by the structure of cellulose itself but also by the approaches taken to degrade to glucose. The production of a robust, low-cost process from cellulose has not yet been achieved.

The benefits of bioethanol are estimated to have the potential to reduce gas emissions by up to 85% over reformulated gasoline. However, numerous production challenges to generate bioethanol from lignocellulosic biomass rather than from starch have led experts in the field to conclude that, in the near future, cellulosic ethanol will not be produced in sufficient quantities to provide at least a partial gasoline replacement or alternative. It is important that second-generation bioethanol production be based on the use of lignocellulosic biomass as a starting material in order to render it environmentally desirable and economically feasible.

Lignocellulosic biomass is a widely available resource which can be used in bioethanol production. However, the presence of hemicellulose along with the cellulose, either when it is used, unprocessed, as part of the feedstock for bio-ethanol production or when, prior to being added to a fermentation unit to produce ethanol, it is converted to pulp and thus as a result of incomplete removal of hemicellulose causes an inhibition of the microorganism activity in the fermentation of cellulose to ethanol. As such, it is preferable to minimize the amount of hemicellulose remaining in the pulp when the latter is used in the production of bioethanol in order to maximize the value thereof.

Moreover, there is also great value to be derived from lignin if such can be extracted in a fashion which renders further processing economically feasible. Lignin is the second most abundant biopolymer in the world (after cellulose). It is a polyphenolic material which is comprised of three phenylpropanoid monomers: p-coumaryl alcohol; coniferyl alcohol; and sinapyl alcohol. The weight average molecular weight (M_{w}) of isolated lignin (milled wood lignin) is dependent on the biomass source and has been recorder to range from 6700 daltons for Eucalyptus globulus to 23 500 daltons for Norway spruce. Lignin has been measured to be present in softwoods in amounts ranging from about 25-35 wt. % to 20-25 wt. % in hardwood. It is also present in herbaceous plants but at much lower concentrations, typically from 15 to 25 wt. %.

US patent application no. 20040244925A1 discloses methods for producing pulp (comprising cellulose) and lignin from lignocellulosic material, such as wood chips. The methods involve acid catalyzed hydrolysis. Lignocellulosic material having a relatively high moisture concentration can be used as the starting material. The lignocellulosic material is impregnated with an acid (preferably nitric acid) and heated. During the heating lignin, is depolymerized at relatively low temperatures, and the acid catalyst is distilled off. The acid catalyst can be collected and recycled after impregnation and heating. The lignocellulosic material is then digested in an alkaline solution under heat, dissolving the lignin and allowing the pulp to be removed. Acid is added to the black liquor to precipitate the lignin which, is then removed. The resultant amber liquor can be further processed into other ancillary products, such as alcohols and/or unicellular proteins.

European patent application no. 2580245A1 discloses a process of fractionation of biomass to obtain lignin, cellulose and hemicelluloses, the process comprises: a. contacting the biomass with 5% to 30% (v/v) aqueous ammonia at a temperature ranging from 50° C. to 200° C. to obtain a first biomass slurry; b. filtering the first biomass slurry to obtain a first filtrate comprising lignin and a first residue comprising cellulose and hemicellulose; c. contacting the first residue with 30% to 90% (v/v) aqueous ammonia at a temperature ranging from 50° C. to 200° C. time to obtain a second biomass slurry; and d. filtering the second biomass slurry to obtain a second filtrate comprising hemicelluloses and a second residue comprising cellulose.

US patent application no. 20210348202A1 discloses a method of processing lignocellulosic biomass comprising: providing soft lignocellulosic biomass feedstock; pretreating the feedstock at pH within the range 3.5 to 9.0 in a single-stage pressurized hydrothermal pretreatment to low severity such that the pretreated biomass is characterized by having a xylan number of 10% or higher; separating the pretreated biomass into a solid fraction and a liquid fraction; hydrolysing the solid fraction with or without addition of supplemental water content using enzymatic hydrolysis catalysed by an enzyme mixture comprising endoglucanase, exoglucanase, B-glucosidase, endoxylanase, xylosidase and acetyl xylan esterase activities; and subsequently mixing the separated liquid fraction, and the hydrolysed solid fraction, whereby xylo-oligomers in the liquid fraction are degraded to xylose monomers by the action of enzyme activities remaining within the hydrolysed solid fraction.

US patent application no. 20100317070A1 discloses a process for converting lignocellulosic materials which are field residues such as cotton stalks and corn stover, process residues such as sugarcane bagasse and sweet sorghum bagasse, woody parts of energy crops such as switchgrass and miscanthus, forest residues or byproducts of the wood processing industries such as sawdust from sawmills to a liquid biofuel by a series of processing steps wherein the feed materials are hydrolysed in three stages and withdrawn as three product streams each consisting of solubilized fragments of one of the three major components of the feed materials and a set of concurrently operating processing steps wherein each of the three product streams is transformed through chemical or biochemical processes into products, such as pure lignin and ethanol, that have a high calorific value and process wherein these products with high calorific value are combined to form a liquid biofuel.

In light of the state-of-the-art with respect to the use of lignocellulosic biomass to generate products for example, organic-based fuels (including but not limited to bioethanol and biofuels), there still exists a need for a process which is capable of being scaled up efficiently which results in streams of separated lignocellulosic biomass constituents which can then be used, for example, in the manufacturing of such fuels.

### SUMMARY OF THE INVENTION

According to an aspect of the present invention, there is provided a method for removing the constituents of a biomass into separate streams, where said method comprises the following steps:
Step 1: providing a biomass feedstock comprising: cellulose; hemicellulose; and lignin;
Step 2: exposing said biomass to a first acidic composition comprising an acid selected from the group consisting of: mineral acids; organic acids; modified acids; synthetic acids; and combinations thereof; for a first period of time sufficient to dissolve at least 50% of the hemicellulose present in said biomass;
Step 3: separating and recovering into a first liquid stream, the dissolved hemicellulose from the remaining biomass;
Step 4: exposing the remaining biomass mixture to a modified Caro's acid selected from the group consisting of:
   composition A; composition B and Composition C;
   wherein said composition A comprises:
      sulfuric acid in an amount ranging from 20 to 70 wt % of the total weight of the composition;
      a compound comprising an amine moiety and a sulfonic acid moiety selected from the group consisting of: taurine; taurine derivatives; and taurine-related compounds; and
      a peroxide;
   wherein said composition B comprises:
      an alkylsulfonic acid; and
      a peroxide; wherein the acid is present in an amount ranging from 40 to 80 wt % of the total weight of the composition and where the peroxide is present in an amount ranging from 10 to 40 wt % of the total weight of the composition;
   wherein said composition C comprises:
      sulfuric acid;
      a compound comprising an amine moiety;
   a compound comprising a sulfonic acid moiety; and
      a peroxide;
   for a first period of time sufficient to dissolve enough of the lignin present in said remaining biomass mixture to obtain a kappa number for the remaining cellulose of less than 5;
Step 5: recovering into a second liquid stream the dissolved lignin from the resulting reaction mixture, wherein said solid portion comprises cellulose fibers with, at most, 7.5 wt % hemicellulose.

Preferably, said first acidic composition comprises an acid selected from the group consisting of: H₂SO₄; HCl; methanesulfonic acid; toluenesulfonic acid; HCl:amino acid; HCl:alkanolamine.

According to a preferred embodiment of the present invention, the hemicellulose step involving acid hydrolysis is replaced with a different hemicellulose removal step selected from the group consisting of: alkaline extraction; peroxide extraction; vapor treatment; microwave treatment; and ionic liquid extraction, and a combination thereof.

According to a preferred embodiment of the present invention, said first acidic composition is added to the biomass in a concentration ranging from 0.1% to 10 wt % and the biomass is heated to a temperature ranging from 50° C. to 150° C. for a period of time sufficient to remove at least 50% of the hemicellulose present in said biomass. Preferably, said remaining biomass mixture contains less than 10% of the amount hemicellulose present prior to exposure to said modified Caro's acid. More preferably, said remaining biomass mixture contains less than 8% of the amount hemicellulose present prior to exposure to said modified Caro's acid. Even more preferably, said remaining biomass mixture contains less than 5% of the amount hemicellulose present prior to exposure to said modified Caro's acid. Yet even more preferably, said remaining biomass mixture contains less than 2% of the amount hemicellulose present prior to exposure to said modified Caro's acid.

According to preferred embodiment of the present invention, the modified Caro's acid (as disclosed in Canadian patent application 3,128,678) comprises: sulfuric acid; a heterocyclic compound; and wherein sulfuric acid and said a heterocyclic compound; are present in a molar ratio of no less than 1:1. Preferably, the sulfuric acid and said heterocyclic compound are present in a molar ratio ranging from 28:1 to 2:1 More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. Preferably, the sulfuric acid and heterocyclic compound are present in a molar ratio ranging from 12:1 to 6:1. Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to preferred embodiment of the present invention, the modified Caro's acid (as disclosed in Canadian patent application 3,128,677) comprises: sulfuric acid; a modifying agent comprising a compound containing an amine group; and wherein sulfuric acid and said compound containing an amine group; are present in a molar ratio of no less than 1:1. Preferably, the sulfuric acid and said compound containing an amine group are present in a molar ratio ranging from 28:1 to 2:1. More preferably, the sulfuric acid and compound containing an amine group are present in a molar ratio ranging from 24:1 to 3:1. Preferably, the sulfuric acid and compound containing an amine group are present in a molar ratio ranging from 20:1 to 4:1. More preferably, the sulfuric acid and compound containing an amine group are present in a molar ratio ranging from 16:1 to 5:1. Preferably, the sulfuric acid and compound containing an amine group are present in a molar ratio ranging from 12:1 to 6:1. According to a preferred embodiment of the present invention, the modifying agent is selected in the group consisting of: TEOA; MEOA; pyrrolidine; DEOA; ethylenediamine; diethylamine; triethylamine; morpholine; MEA-triazine; and combinations thereof. According to a more preferred embodiment of the present invention, the modifying agent is TEOA; MEOA; pyrrolidine; DEOA; ethylenediamine; tricthylamine.

According to preferred embodiment of the present invention, the modified Caro's acid (as disclosed in Canadian patent application 3,128,676) comprises: sulfuric acid; a modifying agent comprising an alkanesulfonic acid; and wherein sulfuric acid and said alkanesulfonic acid are present in a molar ratio of no less than 1:1. Preferably, said alkanesulfonic acid is selected from the group consisting of: alkanesulfonic acids where the alkyl groups range from CI-C6 and are linear or branched; and combinations thereof. Preferably, said alkanesulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkanesulfonic acid is methanesulfonic acid. Also preferably, said alkanesulfonic acid has a molecular weight below 300 g/mol. Also preferably, said alkanesulfonic acid has a molecular weight below 150 g/mol. Preferably, the sulfuric acid and said alkanesulfonic acid and are present in a molar ratio ranging from 28:1 to 2:1. More preferably, the sulfuric acid and alkanesulfonic acid are present in a molar ratio ranging from 24:1 to 3:1. Preferably, the sulfuric acid and alkanesulfonic acid are present in a molar ratio ranging from 20:1 to 4:1. More preferably, the sulfuric acid and alkanesulfonic acid are present in a molar ratio ranging from 16:1 to 5:1. According to a preferred embodiment of the present invention, the sulfuric acid and alkanesulfonic acid are present in a molar ratio ranging from 12:1 to 6:1.

According to preferred embodiment of the present invention, the modified Caro's acid (as disclosed in Canadian patent application 3,128,675) comprises: sulfuric acid; a substituted aromatic compound; and wherein sulfuric acid and said substituted aromatic compound; are present in a molar ratio of no less than 1:1. Preferably, the substituted aromatic compound comprises at least two substituents. More preferably, at least one substituent is an amine group and at least one of the other substituent is a sulfonic acid moiety. According to a preferred embodiment, the substituted aromatic compound comprises three or more substituent. According to a preferred embodiment of the present invention, the substituted aromatic compound comprises at least a sulfonic acid moiety. According to another preferred embodiment of the present invention, the substituted aromatic compound comprises an aromatic compound having a sulfonamide substituent, where the compound can be selected from the group consisting of: benzenesulfonamides; toluenesulfonamides; substituted benzenesulfonamides; and substituted toluenesulfonamides. Preferably, the sulfuric acid and said substituted aromatic compound and are present in a molar ratio ranging from 28:1 to 2:1. More preferably, the sulfuric acid and substituted aromatic compound are present in a molar ratio ranging from 24:1 to 3:1. Preferably, the sulfuric acid and substituted aromatic compound are present in a molar ratio ranging from 20:1 to 4:1. More preferably, the sulfuric acid and substituted aromatic compound are present in a molar ratio ranging from 16:1 to 5:1. Preferably, the sulfuric acid and substituted aromatic compound are present in a molar ratio ranging from 12:1 to 6:1.

According to preferred embodiment of the present invention, the modified Caro's acid (as disclosed in Canadian patent application 3,128,674) comprises: sulfuric acid; a modifying agent comprising an arylsulfonic acid; and optionally, a compound containing an amine group; wherein sulfuric acid and said a arylsulfonic acid; are present in a molar ratio of no less than 1:1. Preferably, the compound containing an amine group is selected from the group consisting of: imidazole; N-methylimidazole; triazole; monoethanolamine (MEOA); diethanolamine (DEOA); triethanolamine (TEOA); pyrrolidine and combinations thereof. According to a preferred embodiment of the present invention, sulfuric acid and the peroxide are present in a molar ratio of approximately 1:1. Preferably, the sulfuric acid and said arylsulfonic acid and are present in a molar ratio ranging from 28:1 to 2:1. More preferably, the sulfuric acid and arylsulfonic acid are present in a molar ratio ranging from 24:1 to 3:1. Preferably, the sulfuric acid and arylsulfonic acid are present in a molar ratio ranging from 20:1 to 4:1. More preferably, the sulfuric acid and arylsulfonic acid are present in a molar ratio ranging from 16:1 to 5:1. According to a preferred embodiment of the present invention, the sulfuric acid and arylsulfonic acid are present in a molar ratio ranging from 12:1 to 6:1. Also preferably, said arylsulfonic acid has a molecular weight below 300 g/mol. Also preferably, said arylsulfonic acid has a molecular weight below 150 g/mol. Even more preferably, said arylsulfonic acid is selected from the group consisting of: orthanilic acid; metanilic acid; sulfanilic acid; toluenesulfonic acid; benzenesulfonic acid; and combinations thereof.

According to preferred embodiment of the present invention, the modified Caro's acid (as disclosed in Canadian patent application 3,128,673) comprises: sulfuric acid; a heterocyclic compound; an alkanesulfonic acid; and wherein sulfuric acid and said a heterocyclic compound; are present in a molar ratio of no less than 1:1. Preferably, said aqueous acidic composition comprising: sulfuric acid; a heterocyclic compound; an arylsulfonic acid; and wherein sulfuric acid and said a heterocyclic compound; are present in a molar ratio of no less than 1:1. Preferably, the arylsulfonic acid is toluenesulfonic acid. Preferably, the sulfuric acid, the heterocyclic compound and the alkanesulfonic acid are present in a molar ratio ranging from 28:1:1 to 2:1:1. More preferably, the sulfuric acid the heterocyclic compound and the alkanesulfonic acid are present in a molar ratio ranging from 24:1:1 to 3:1:1. Preferably, the sulfuric acid, the heterocyclic compound and the alkanesulfonic acid are present in a molar ratio ranging from 20:1:1 to 4:1:1. More preferably, the sulfuric acid, the heterocyclic compound and the alkanesulfonic acid are present in a molar ratio ranging from 16:1:1 to 5:1:1. According to a preferred embodiment of the present invention, the sulfuric acid and heterocyclic compound are present in a molar ratio ranging from 12:1:1 to 6:1:1. Also preferably, said heterocyclic compound has a molecular weight below 300 g/mol. Also preferably, said heterocyclic compound has a molecular weight below 150 g/mol. Even more preferably, said heterocyclic compound is selected from the group consisting of: imidazole; triazole; n-methylimidazole; and combinations thereof. Preferably, the alkanesulfonic acid is selected from the group consisting of: alkylsulfonic acids where the alkyl groups range from C1-C6 and are linear or branched; and combinations thereof. Preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkylsulfonic acid is methanesulfonic acid.

According to preferred embodiment of the present invention, the modified Caro's acid (as disclosed in Canadian patent application 3,128,672) comprises: sulfuric acid; a carbonyl-containing nitrogenous base compound; and wherein sulfuric acid and said a carbonyl-containing nitrogenous base compound; are present in a molar ratio of no less than 1:1. According to a preferred embodiment of the present invention, the carbonyl-containing nitrogenous base compound is selected from the group consisting of: caffeine; lysine; creatine; glutamine; creatinine; 4-aminobenzoic acid; glycine; NMP (N-methyl-2-pyrrolidinone); histidine; DMA (N,N-dimethylacetamide); arginine; 2,3-pyridinedicarboxylic acid; hydantoin; and combinations thereof. Preferably, the sulfuric acid and said carbonyl-containing nitrogenous base compound and are present in a molar ratio ranging from 28:1 to 2:1. More preferably, the sulfuric acid and carbonyl-containing nitrogenous base compound are present in a molar ratio ranging from 24:1 to 3:1. Preferably, the sulfuric acid and carbonyl-containing nitrogenous base compound are present in a molar ratio ranging from 20:1 to 4:1. More preferably, the sulfuric acid and carbonyl-containing nitrogenous base compound are present in a molar ratio ranging from 16:1 to 5:1. According to a preferred embodiment of the present invention, the sulfuric acid and carbonyl-containing nitrogenous base compound are present in a molar ratio ranging from 12:1 to 6:1.

Preferably, it is also desirable to overcome at least some of the drawbacks associated with the contamination by the individual constituents (lignin, hemicellulose and cellulose) in one another's streams. According to a preferred embodiment of the present invention, it is desirable to pre-treat lignocellulosic biomass to remove as much hemicellulose as possible to as to yield a lignin-rich liquid after delignification. Preferably, the lignin-rich liquid obtained after delignification will allow a more efficient conversion to LDO (lignin depolymerized organics) biofuel.

Preferably, the cellulose obtained after delignification will allow a more efficient conversion to bioethanol due to the low amounts of hemicellulose and lignin (or practical absence thereof) which will allow the fermentation of cellulose into bioethanol to be more efficient and not require genetically modified microorganisms, which will increase the cost of manufacturing. The inventors have previously determined that characteristics of the cellulose obtained from a specific type of delignification approach have a substantial impact on the downstream hydrolysis of said cellulose. In that respect, the present invention allows operators to minimize operational costs by implementing a multi-step approach to low-energy delignification to obtain distinct streams of the three main constituents of lignocellulosic biomass.

### BRIEF DESCRIPTION OF THE FIGURES

The invention may be more completely understood in consideration of the following description of various embodiments of the invention in connection with the accompanying FIGURE, in which:

FIG. 1 is a graph of the xylose extraction yields as a function of time with different concentrations of dilute sulfuric acid.

### DETAILED DESCRIPTION OF THE INVENTION

The delignification of biomass according to conventional approaches, such a kraft pulping, yields a pulp which is still high in lignin and hemicellulose. The most common process for pulp delignification is the kraft process. In the kraft process, wood chips are converted to wood pulp. The multi-step kraft process consists of a first step where wood chips are impregnated with a chemical solution. This is done by wetting wood chips and pre-heating them with steam. This swells the wood chips and expels the air present in them and replaces the air with the liquid. Then the chips are saturated with a black liquor and a white liquor. The black liquor is a resulting product from the kraft process. It contains water, lignin residues, hemicellulose, and inorganic chemicals. White liquor is a strong alkaline solution comprising sodium hydroxide and sodium sulfide. Once the wood chips have been soaked in the different solutions, they undergo cooking. To achieve delignification in the wood chips, the cooking is carried out for a few hours at temperatures reaching up to 176° C. At these temperatures, the lignin degrades to yield water soluble fragments. The remaining cellulosic fibers are collected and washed after the cooking step.

Biofuel production is another potential application for the kraft process. One of the current drawbacks of biofuel production is that it requires the use of plant parts (such as seeds) in order to transform carbohydrates into fuel in a reasonably efficient process. The carbohydrates could be obtained from cellulosic fibers, by using non-food grade biomass in the kraft process. However, the energy intensive nature of the kraft process for delignification makes this a less commercially viable option. In order to build a plant based chemical resource cycle, there is a great need for energy efficient processes which can utilize plant-based feedstocks that don't compete with human food production.

While the kraft pulping process is the most widely used chemical pulping process in the world, it is extremely energy intensive and has other drawbacks, for example, substantial odours emitted around pulp producing plants.

The applicant has a patented delignification process which produces a bio-crude feedstock that is substantially free of cellulose derivatives and hence its composition is enhanced compared to pyrolysis bio-crude. This bio-crude feedstock can be achieved by performing a delignification reaction using a modified Caro's acid composition selected from the group consisting of composition A; composition B and Composition C;
wherein said composition A comprises:
   sulfuric acid in an amount ranging from 20 to 70 wt % of the total weight of the composition;
   a compound comprising an amine moiety and a sulfonic acid moiety selected from the group consisting of: taurine; taurine derivatives; and taurine-related compounds; and
   a peroxide;
wherein said composition B comprises:
   an alkylsulfonic acid; and
   a peroxide; wherein the acid is present in an amount ranging from 40 to 80 wt % of the total weight of the composition and where the peroxide is present in an amount ranging from 10 to 40 wt % of the total weight of the composition;
wherein said composition C comprises:
   sulfuric acid;
   a compound comprising an amine moiety;
   a compound comprising a sulfonic acid moiety; and
   a peroxide.

The pyrolysis of delignified biomass thermally decomposes the liquid portion of the delignified biomass in the absence of air to produce a liquid (bio-crude) through the application of a high heat transfer rate to the biomass particles. The applicant's patented delignification process (using a modified Caro's acid) separates cellulose from the other biomass constituents (lignin and hemicellulose) at a recovery rate of +99% and can depolymerize lignin and hemicellulose into a liquid-rich organic liquid called Lignin-Hemicellulose-Depolymerized-Organics (LHDO). The applicant's LHDO contains virtually no aldehydes, and all carboxylic acids are converted once the LHDO is upgraded using hydrodeoxygenation (HDO). This eliminates the need for bio-crude aldehyde's role in bio-crude stability from thermal application or stability over time. Aldehydes present in pyrolysis bio-crude react with sugars to form higher-molecular-weight resins and oligomers via polymerization and condensation; oligomerization reactions lead to coke formation, which is highly undesirable in bio-crudes. Furthermore, the applicant's LHDO produces minimum and almost negligible char/coke during the HDO process and the upgraded LHDO is completely miscible with Jet and Diesel Fuels without the need for pre-treatment step used for pyrolysis bio-crude by oxidation followed by mild temperature hydrotreating stage to eliminate polymerization that occurred through during hydrocracking process.

It is noteworthy to point out that current pyrolysis of biomass generally yields a large amount of bio-char (up to 30-40%). This is highly undesirable as bio-char is low in value and the potential to use the remaining bio-crude as a fuel additive, which is the high value product, is greatly diminished to the large amount of conversion of biomass into bio-char.

Preferably, said lignin-rich feedstock comprises more than 80 wt % of lignin-based compounds obtained from delignification of biomass. More preferably, said lignin-rich feedstock comprises more than 85 wt % of lignin-based compounds obtained from delignification of biomass. Even more preferably, said lignin-rich feedstock comprises more than 90 wt % of lignin-based compounds obtained from delignification of biomass. Yet even more preferably, said lignin-rich feedstock comprises more than 95 wt % of lignin-based compounds obtained from delignification of biomass. According to a preferred embodiment of the method of the present invention, the lignin-rich feedstock comprises more than 97.5 wt % of lignin-based compounds obtained from delignification of biomass.

In an application using a resulting stream obtained from a preferred embodiment of the process of the present invention, one can produce biofuel using a lignin-rich feedstock using a method comprising:
providing a lignin-rich feedstock, wherein said lignin-rich feedstock comprises more than 60 wt % of lignin-based compounds obtained from delignification of biomass, where said lignin-based compounds are selected from the group consisting of: lignin-derived monomers, lignin-derived dimers, lignin-derived oligomers and combinations thereof; wherein said lignin-rich feedstock is substantially free of hemicellulose and cellulose;
performing a hydrodeoxygenation reaction on said lignin-rich feedstock, wherein the hydrodeoxygenation reaction is carried out in a hydrogen-rich source at a temperature ranging from 300° C. to 400° C. under a H₂ pressure ranging from 15 to 50 bar, more preferably 35 bar, in the presence of a catalyst adapted for HDO reactions, for a period of time sufficient to result in an upgraded oil having a TAN of about 2.5 mg KOH/g and viscosity of 3.4 cP.

In the context of manufacture of bioethanol, it is to be understood that the presence of a low amount of hemicellulose (including but not limited to xylose) may still yield generally much improved yields in comparison to conventional cellulose which contains larger percentages of hemicellulose (including but not limited to xylose) scattered therein. For instance, since xylose is in general, the second most common sugar found in lignocellulosic biomass, it is expected that it be present in a range of 15-25% in a conventional pulp after delignification.

Preferably, the addition of a substantially free of xylose biomass additive allows for an increase in the generation of ethanol in a fermentation unit when the biomass additive is used as part of the organic waste being fermented or as the entire organic load in the fermentation unit. When converting cellulose to ethanol, it is preferable to have a biomass where the cellulose is substantially free of hemicellulose. Preferably, the biomass contains at most 10% of the original hemicellulose content from harvested lignocellulosic biomass. Preferably, the biomass contains at most 8% of the original hemicellulose content from harvested lignocellulosic biomass. Preferably, the biomass contains at most 6% of the original hemicellulose content from harvested lignocellulosic biomass. Preferably, the biomass contains at most 5% of the original hemicellulose content from said harvested lignocellulosic biomass. Preferably, the biomass contains at most 4% of the original hemicellulose content from said harvested lignocellulosic biomass. Preferably, the biomass contains at most 3% of the original hemicellulose content from said harvested lignocellulosic biomass. Preferably, the biomass contains at most 2% of the original hemicellulose content from the harvested lignocellulosic biomass. Preferably, the biomass additive contains at most 1% of the original hemicellulose content from said harvested lignocellulosic biomass. Preferably, the biomass contains at most 0.5% of said original hemicellulose content from the harvested lignocellulosic biomass.

When resorting to a biomass which was delignified using a modified Caro's acid and performed according to a process described herein, the remaining hemicellulose present as xylose along with the cellulose can hover as low as 7.5 wt % or even less of the total weight of the pulp being used. However, it is more desirable to easily separate out the hemicellulose from the lignin and, as such, incorporating a lignocellulosic feedstock pre-treatment step using an acid selected from the group consisting of: H₂SO₄; HCl; methanesulphonic acid; toluenesulfonic acid; HCl:amino acid; HCl:alkanolamine; H₂SO₄:amino acid; H₂SO₄:alkanolamine; H₂SO₄:taurine; H₂SO₄:taurine-related compound, etc.

Preferably, since the hemicellulose is mostly removed prior to the delignification, the chemicals used in the delignification of the lignocellulosic biomass (i.e., modified Caro's acids) are practically solely used for removing and solubilizing the lignin from the remaining biomass mixture. After the delignification is deemed sufficiently complete for the purposes of the operator, the solids (cellulose) are separated from the liquid containing the modified Caro's acid as well as lignin fragments. Preferably, employing this approach maximizes the hemicellulose removal from the cellulose and allows conventional enzymes or the like to be used to convert the extracted cellulose into ethanol. This also removes the necessity of finding a genetically modified ethanologenic organism capable of converting glucose and xylose into ethanol, thus streamlining the process, lowering costs, and ensuring a more efficient conversion of lignocellulosic biomass into ethanol.

According to a preferred embodiment of the present invention, there is provided a process capable of substantially separating out the three main constituents of lignocellulosic biomass. Preferably, the process employs steps where the minimum input of energy is required in order to separate out said constituents. Preferably, the separation of the three constituents of biomass allows further processing for a number of applications which benefit from a higher purity of each of the constituents. This higher purity is meant to be understood as the hemicellulose being substantially free of cellulose and lignin; the cellulose being substantially free of hemicellulose and lignin; and lignin the being substantially free of cellulose and hemicellulose. Preferably, substantially free is meant to be understood as the main constituent being present in an amount of at least 90 wt % of total weight of the stream of interest, i.e., hemicellulose which is substantially free of cellulose and lignin would be understood as being a stream of hemicellulose which contains at least 90 wt % of hemicellulose, the same applying to the other streams. Preferably, substantially free is meant to be understood as the main constituent being present in an amount of at least 95 wt % of total weight of the stream of interest. Preferably, substantially free is meant to be understood as the main constituent being present in an amount of at least 96 wt % of total weight of the stream of interest. Preferably, substantially free is meant to be understood as the main constituent being present in an amount of at least 97 wt % of total weight of the stream of interest. Preferably, substantially free is meant to be understood as the main constituent being present in an amount of at least 98 wt % of total weight of the stream of interest.

In an application using a resulting stream obtained from a preferred embodiment of the process of the present invention, adding a cellulose-rich biomass which is essentially devoid of hemicellulose (which contains the xylose residues) enables one to increase the generation of ethanol from the fermentation of cellulose.

According to a preferred embodiment of the present invention, the cellulose is an unbleached cellulose which has a hemicellulose weight content of 7.5 wt % or lower. Preferably, the cellulose is obtained by the delignification of a lignocellulosic biomass feedstock through the exposure of such to a modified Caro's acid as per the following processes. A preferred embodiment of the process to delignify biomass comprises the steps of:
providing a vessel;
providing biomass comprising lignin, hemicellulose and cellulose fibers into said vessel;
pre-treating the biomass by exposing it to an acid composition for a period of time sufficient to remove over 50 wt % of said hemicellulose from said biomass mixture;
extracting dissolved hemicellulose from the biomass mixture;
providing a sulfuric acid component;
providing a peroxide component;
exposing said remaining biomass to said sulfuric acid source and peroxide component;
allowing said sulfuric acid source and peroxide component to come into contact with said biomass for a period of time sufficient to a delignification reaction to occur and remove over 90 wt % of said lignin from said remaining biomass.

Preferably, the remaining biomass comprising mostly lignin and cellulose fibers is exposed to a modified Caro's acid composition selected from the group consisting of: composition A; composition B and Composition C;
wherein said composition A comprises:
   sulfuric acid in an amount ranging from 20 to 70 wt % of the total weight of the composition;
   a compound comprising an amine moiety and a sulfonic acid moiety selected from the group consisting of: taurine; taurine derivatives; and taurine-related compounds; and
   a peroxide;
wherein said composition B comprises:
   an alkylsulfonic acid; and
   a peroxide; wherein the acid is present in an amount ranging from 40 to 80 wt % of the total weight of the composition and where the peroxide is present in an amount ranging from 10 to 40 wt % of the total weight of the composition;
wherein said composition C comprises:
   sulfuric acid;
   a compound comprising an amine moiety;
   a compound comprising a sulfonic acid moiety; and
   a peroxide.

According to a preferred embodiment of the present invention, exposing said remaining biomass to said modified Caro's acid composition will allow the delignification reaction to occur and remove over 90 wt % of said lignin from said biomass.

Preferably, the delignification reaction is carried out at a temperature below 55° C. by a method selected from the group consisting of:
adding water into said vessel;
adding said remaining biomass into said vessel; and
using a heat exchanger.

The resulting streams of the above process according to a preferred embodiment of the present invention include: a stream rich in dissolved hemicellulose depolymerized during the hydrolysis pre-treatment; a cellulose stream comprising solid cellulose fibers; and a lignin-rich stream comprising the lignin removed from the remaining biomass.

According to a preferred embodiment of the method of the present invention, one advantage of this approach is that compared to other approaches using the entire biomass to generate biofuel, this approach focuses on the LDO present within the lignin-rich stream. Consequently, the portion of aromatic carbons (present on lignin and lignin monomers, dimers and oligomers resulting from the delignification) is substantially higher than in the processes which employ the entire biomass (cellulose, lignin and hemicellulose). For example, in softwood trees, the proportion of cellulose is in the range of 40-50%, the percentage of lignin can range from 30-40% and the remaining balance is hemicellulose. By pre-treating and removing the hemicellulose prior to the delignification of the remaining biomass, it becomes much easier to separate the hemicellulose from the other biomass constituents such as lignin and cellulose. Moreover, by subsequently removing the primary constituent of lignocellulosic biomass (cellulose) from the remaining biomass constituent (lignin) to use the latter to manufacture biofuel, one increases the aromatic carbon compositions and consequently, increases the value of the biofuel.

According to another aspect of the present invention, there is provided a process to perform a controlled exothermic delignification of lignocellulosic biomass, said process comprising the steps of:
providing a vessel;
providing biomass comprising lignin, hemicellulose and cellulose fibers into said vessel;
pre-treating the biomass by exposing it to an acid composition for a period of time sufficient to remove over 50 wt % of said hemicellulose from said biomass mixture;
extracting dissolved hemicellulose from the remaining biomass mixture;
providing an aqueous acidic composition comprising a sulfuric acid component;
providing a peroxide component;
providing a modifier;
exposing said remaining biomass mixture to said sulfuric acid source and peroxide component, creating a reaction mass;
allowing said sulfuric acid source and peroxide component to come into contact with said remaining biomass mixture for a period of time sufficient to a delignification reaction to occur and remove over 97 wt % of said lignin from said remaining biomass mixture, to yield substantially lignin-free cellulose; and
wherein said lignin is recovered separately from the cellulose, for further processing.

According to a preferred embodiment of the method of the present invention, the stream of LDO/LHDO is exposed to a pH adjustment prior to undergoing upgrading.

According to a preferred embodiment of the method of the present invention, the stream of LDO/LHDO is substantially free of cellulose (i.e. less than 5 wt % cellulose). More preferably, the stream of LDO/LHDO contains less than 2 wt % cellulose. Even more preferably, the stream of LDO/LHDO contains less than 1 wt % cellulose. Yet even more preferably, the stream of LDO/LHDO contains less than 0.5 wt % cellulose. Yet even more preferably, the stream of LDO/LHDO contains less than 0.1 wt % cellulose.

It is worthy of mention that almost all efforts for lignocellulosic biomass conversion into fuels have failed due to undesired interactions among the three main biomass constituents; cellulosic ethanol represents a clear example of the aforementioned, beside the undesired properties of pyrolysis bio-oil.

According to yet another aspect of the present invention, there is provided a process to delignify biomass and recover a liquid stream which is substantially pure lignin and/or lignin monomers (i.e. lignin-based compounds make up over 90 wt. % of the liquid stream), said process comprising the steps of:
providing a vessel;
providing biomass comprising lignin, hemicellulose and cellulose fibers into said vessel;
pre-treating the biomass by exposing it to an acid composition for a period of time sufficient to remove over 50 wt % of said hemicellulose from said biomass mixture;
extracting dissolved hemicellulose from the remaining biomass mixture;
providing an aqueous acidic composition comprising a sulfuric acid component;
providing a peroxide component;
exposing said remaining biomass mixture to said sulfuric acid source and peroxide component, creating a reaction mass;
allowing said sulfuric acid source and peroxide component to come into contact with said remaining biomass mixture for a period of time sufficient to a delignification reaction to occur and remove over 95 wt % of said lignin from said remaining biomass mixture, to yield substantially lignin-free cellulose; and
controlling the temperature of the delignification reaction by addition of water into said vessel.

According to yet another aspect of the present invention, there is provided a process to delignify biomass and recover a substantially hemicellulose free liquid stream of lignin and lignin monomers, said process comprising the steps of:
providing a vessel;
providing biomass comprising lignin, hemicellulose and cellulose fibers into said vessel;
pre-treating the biomass by exposing it to an acid composition for a period of time sufficient to remove over 50 wt % of said hemicellulose from said biomass mixture;
extracting dissolved hemicellulose from the remaining biomass mixture;
providing an aqueous acidic composition comprising a sulfuric acid component;
providing a peroxide component;
exposing said remaining biomass mixture to said sulfuric acid source and peroxide component, creating a reaction mass;
allowing said sulfuric acid source and peroxide component to come into contact with said remaining biomass mixture for a period of time sufficient to a delignification reaction to occur and remove over 95 wt % of said lignin from said remaining biomass mixture, to yield substantially lignin-free cellulose; and
controlling the temperature of the delignification reaction by controlling the addition of biomass into said vessel.

According to a preferred embodiment of the present invention, the remaining biomass mixture comprising substantially only lignin and cellulose is exposed to a modified Caro's acid composition selected from the group consisting of composition A; composition B and Composition C; wherein said composition A comprises:
sulfuric acid in an amount ranging from 20 to 70 wt % of the total weight of the composition;
a compound comprising an amine moiety and a sulfonic acid moiety selected from the group consisting of taurine; taurine derivatives; and taurine-related compounds; and
a peroxide;
   wherein said composition B comprises:
an alkylsulfonic acid; and
a peroxide; wherein the acid is present in an amount ranging from 40 to 80 wt % of the total weight of the composition and where the peroxide is present
in an amount ranging from 10 to 40 wt % of the total weight of the composition;
   wherein said composition C comprises:
sulfuric acid;
a compound comprising an amine moiety;
a compound comprising a sulfonic acid moiety; and
a peroxide.

According to a preferred embodiment of the present invention, the remaining biomass mixture comprising substantially only lignin and cellulose fibers is exposed to a modified Caro's acid composition for a period of time sufficient to a delignification reaction to occur and remove over 95 wt % of said lignin and preferably most of the remaining hemicellulose from said biomass. Preferably, the stream of LHDO/LDO is removed upon completion of the delignification reaction for further processing into biofuel.

According to a preferred embodiment of the present invention, the remaining biomass mixture comprising substantially only lignin and cellulose fibers consumes less of the peroxide during the delignification step, as it no longer contains a sizable amount of hemicellulose. Hence, the modified Caro's acid composition would more specifically target the lignin and would not be used up in dissolving hemicellulose and therefore slowing down the delignification.

Preferably, said compound comprising an amine moiety and a sulfonic acid moiety is selected from the group consisting of taurine; taurine derivatives; and taurine-related compounds.

Preferably, said taurine derivative or taurine-related compound is selected from the group consisting of: taurolidine; taurocholic acid; tauroselcholic acid; tauromustine; 5-taurinomethyluridine and 5-taurinomethyl-2-thiouridine; homotaurine (tramiprosate); acamprosate; and taurates as well as aminoalkylsulfonic acids, where the alkyl is selected from the group consisting of C₁-C₅ linear alkyl and C₁-C₅ branched alkyl. Preferably, said linear alkylaminosulfonic acid is selected from the group consisting of: methyl; ethyl (taurine); propyl; and butyl. Preferably, said branched aminoalkylsulfonic acid is selected from the group consisting of: isopropyl; isobutyl; and isopentyl.

According to a preferred embodiment of the present invention, said compound comprising an amine moiety and a sulfonic acid moiety is taurine.

According to a preferred embodiment of the present invention, said sulfuric acid and a compound comprising an amine moiety and a sulfonic acid moiety are present in a molar ratio of no less than 3:1.

According to a preferred embodiment of the present invention, said compound comprising an amine moiety is an alkanolamine is selected from the group consisting of: monoethanolamine; diethanolamine; triethanolamine; and combinations thereof.

Preferably, said compound comprising a sulfonic acid moiety is selected from the group consisting of: alkylsulfonic acids; arylsulfonic acids; and combinations thereof. Preferably, said alkylsulfonic acid is selected from the group consisting of: alkylsulfonic acids where the alkyl groups range from C₁-C₆ and are linear or branched; and combinations thereof. More preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. According to a preferred embodiment of the present invention, said arylsulfonic acid is selected from the group consisting of: toluenesulfonic acid; benzesulfonic acid; and combinations thereof.

According to a preferred embodiment of the present invention, the temperature of the remaining biomass mixture is kept below 55° C. for the duration of the delignification reaction. Preferably, the temperature of the remaining biomass mixture is kept below 50° C. for the duration of the delignification reaction. According to another preferred embodiment of the present invention, the temperature of the remaining biomass mixture is kept below 45° C. for the duration of the delignification reaction. According to a preferred embodiment of the present invention, the temperature of the remaining biomass mixture is kept below 40° C. for the duration of the delignification reaction.

According to a preferred embodiment of the present invention, the lignin remaining after the delignification step is less than 5 wt. % of the solid portion. Preferably, the lignin remaining after the delignification step is less than 2 wt. % of the solid portion. More preferably, the lignin remaining after the delignification step is less than 1 wt. % of the solid portion.

According to a preferred embodiment of the present invention, the temperature of the remaining biomass mixture is controlled throughout the delignification reaction to subsequent additions of a solvent (water) to progressively lower the slope of temperature increase per minute from less than 1° C. per minute to less than 0.5° C. per minute.

According to another preferred embodiment of the present invention, the temperature of the remaining biomass mixture is controlled by an addition of a solvent (water) to reduce the slope of temperature increase per minute of the reaction mass to less than 1° C. per minute.

According to yet another preferred embodiment of the present invention, the temperature of the remaining biomass mixture is controlled by a second addition of a solvent (water) to reduce the slope of temperature increase per minute of the reaction mass to less than 0.7° C. per minute.

Preferably, the temperature of the remaining biomass mixture is controlled by a third addition of a solvent (water) to reduce the slope of temperature increase per minute of the reaction mass to less than 0.3° C. per minute.

Preferably, the temperature of the remaining biomass mixture is controlled by a fourth addition of a solvent (water) to reduce the slope of temperature increase per minute of the reaction mass to less than 0.1° C. per minute.

According to a preferred embodiment of the present invention, the kappa number of the resulting cellulose is below 5.

According to a preferred embodiment of the present invention, there is provided a process to delignify biomass using an aqueous acidic composition comprising:
sulfuric acid;
a heterocyclic compound; and
a peroxide.

According to another preferred embodiment of the present invention, there is provided a process to delignify biomass using an aqueous acidic composition comprising:
sulfuric acid;
a heterocyclic compound; and
wherein sulfuric acid and said a heterocyclic compound; are present in a molar ratio of no less than 1:1.

Preferably, the sulfuric acid and said heterocyclic compound are present in a molar ratio ranging from 28:1 to 2:1. More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. According to a preferred embodiment of the present invention, the sulfuric acid and heterocyclic compound are present in a molar ratio ranging from 12:1 to 6:1.

Preferably, the sulfuric acid and the peroxide are present in a molar ratio ranging from 7:1 to 1:7.5. More preferably, the sulfuric acid and the peroxide are present in a molar ratio ranging from 3:1 to 1:3. Even more preferably, the sulfuric acid and the peroxide are present in a molar ratio ranging from 2:1 to 1:1.

Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to an aspect of the present invention, there is provided a process to delignify biomass, such as wood using an aqueous acidic composition comprising:
sulfuric acid;
a heterocyclic compound; and
a peroxide.
wherein the sulfuric acid and the heterocyclic compound are present in a mole ratio ranging from 2:1 to 28:1.

Preferably, said sulfuric acid, said compound comprising an amine moiety and a sulfonic acid moiety and said peroxide are present in a molar ratio of no less than 1:1:1. Also preferably, said sulfuric acid, said compound comprising an amine moiety and a sulfonic acid moiety and said peroxide are present in a molar ratio of no more than 15:1:1.

According to a preferred embodiment of the present invention, said sulfuric acid and said compound comprising an amine moiety and a sulfonic acid moiety are present in a molar ratio of no less than 3:1.

According to a preferred embodiment of the present invention, said compound comprising an amine moiety and a sulfonic acid moiety is selected from the group consisting of: taurine; taurine derivatives; and taurine-related compounds.

According to a preferred embodiment of the present invention, said taurine derivative or taurine-related compound is selected from the group consisting of: taurolidine; taurocholic acid; tauroselcholic acid; tauromustine; 5-taurinomethyluridine and 5-taurinomethyl-2-thiouridine; homotaurine (tramiprosate); acamprosate; and taurates; as well as aminoalkylsulfonic acids where the alkyl is selected from the group consisting of C₁-C₅ linear alkyl and C₁-C₅ branched alkyl. Preferably, said linear alkylaminosulfonic acid is selected from the group consisting of: methyl; ethyl (taurine); propyl; and butyl.

Preferably, said branched aminoalkylsulfonic acid is selected from the group consisting of: isopropyl; isobutyl; and isopentyl.

According to a preferred embodiment of the present invention, said compound comprising an amine moiety and a sulfonic acid moiety is taurine.

According to a preferred embodiment of the present invention, said sulfuric acid and a compound comprising an amine moiety and a sulfonic acid moiety are present in a molar ratio of no less than 3:1.

According to a preferred embodiment of the present invention, said compound comprising an amine moiety is an alkanolamine is selected from the group consisting of: monoethanolamine; diethanolamine; triethanolamine; and combinations thereof.

According to a preferred embodiment of the present invention, said compound comprising a sulfonic acid moiety is selected from the group consisting of: alkylsulfonic acids and combinations thereof.

According to a preferred embodiment of the present invention, said alkylsulfonic acid is selected from the group consisting of: alkylsulfonic acids where the alkyl groups range from C₁-C₆ and are linear or branched; and combinations thereof.

According to a preferred embodiment of the present invention, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof.

According to a preferred embodiment of the present invention, said alkylsulfonic acid; and said peroxide is present in a molar ratio of no less than 1:1.

According to a preferred embodiment of the present invention, said compound comprising a sulfonic acid moiety is methanesulfonic acid.

According to a preferred embodiment of the present invention, in Composition C, said sulfuric acid and said a compound comprising an amine moiety and said compound comprising a sulfonic acid moiety are present in a molar ratio of no less than 1:1:1.

According to a preferred embodiment of the present invention, in Composition C, said sulfuric acid, said compound comprising an amine moiety and said compound comprising a sulfonic acid moiety are present in a molar ratio ranging from 28:1:1 to 2:1:1.

### Experimental Data

### Pretreatment of the Biomass

The following experimentation was conducted using canola straw as the biomass. The canola straw was characterized to determine the content of acid-insoluble lignin (also known as Klason lignin) as well as carbohydrate composition. The carbohydrate composition gives an indication of cellulose and hemicellulose distribution within the biomass. Results of the characterization of the canola straw are shown in Table 4.

TABLE 4
Results of the characterization of canola
straw used in the experiments.

| Parameter | Units | Result |
|---|---|---|
| Klason lignin | %, OD basis | 16.1% |
| Arabinan | %, extracted OD basis | 1.2% |
| Xylan | %, extracted OD basis | 11.6% |
| Mannan | %, extracted OD basis | 1.0% |
| Galactan | %, extracted OD basis | 1.1% |
| Glucan | %, extracted OD basis | 25.3% |

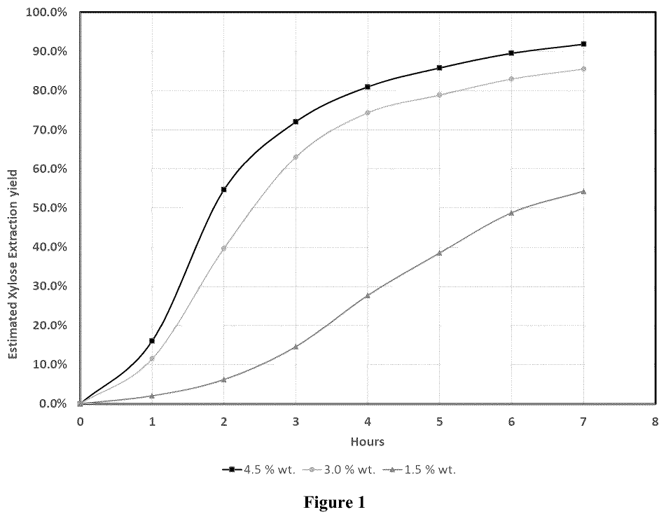

Pretreatment of the canola was conducted by exposing the untreated, raw canola biomass to a solution of dilute sulfuric acid at a temperature of 100° C. Different concentrations of sulfuric acid ranging from 1.5% wt. to 4.5% wt. were employed to determine C5 sugar extraction yields. The biomass was added to the dilute acid solution in a 5% wt. loading. The reaction was monitored overtime and aliquots of the reaction mixture were taken at different timepoints to determine extraction yields over time. FIG. 1 shows the xylose extraction yields as a function of time with different concentrations of dilute sulfuric acid; whereas Table 5 shows the overall maximum extraction yields obtained.

TABLE 5
Results of the characterization of canola
straw used in the experiments.

| H₂SO₄ % wt. | Max. Extraction yield |
|---|---|
| 1.5 | 54.8% |
| 3.0 | 89.2% |
| 4.5 | 91.9% |

### Delignification

Samples of the pretreated and unpretreated canola were then exposed to a delignification reaction according to the method described herein. A H₂SO₄:H₂O₂:taurine blend with a 10:10:1 molar ratio was prepared in a beaker by mixing 134.5 g of concentrated sulfuric acid (93%), 16.0 g of taurine, and 149.6 g of hydrogen peroxide (29%). As the mixing releases a large amount of heat, the beaker was placed in an ice bath. The pH of the resulting composition was less than 0.5. The canola sample (either pretreated or untreated) was then added into the blend as 3% wt. solids loading (9 g). The reaction was left stirring at 35° C. for 3 hours, after which the solids were extracted from the liquid and a yield of the solids was obtained. The remaining liquid was employed for a second delignification reaction where new biomass was added as 3% wt. solids loading of the weighed spent liquor. This process was repeated for a total of 2 recycles post-fresh blend, where the second recycle was left stirring for 18 hours instead of 3 hours for convenience. Table 6 shows the yield of solid cellulose for the fresh blend and the 2 recycles for both the untreated and pre-treated canola biomass. Cellulose yield was calculated as mass of cellulose recovered with respect to the mass of initial biomass.

TABLE 6
Cellulose solids yield of the delignification of
untreated canola biomass and canola biomass pretreated
according to the method described herein.

| Blend ID | Pretreated canola | Untreated canola |
|---|---|---|
| Fresh blend | 40.65 | 40.25 |
| Recycle 1 | 40.76 | 36.87 |
| Recycle 2 | 40.38 | 34.88 |

The results in Table 6 indicate that the delignification of pretreated biomass results in higher, more consistent yields, while the delignification of untreated biomass produces less cellulose yields due to hemicellulose dissolution.

Hydrogen peroxide consumption in the reaction is an important metric as it is the only chemical consumed in the reaction and determines chemical consumption in large scale facilities. During these reactions, hydrogen peroxide was monitored after each recycle to determine chemical consumption. Table 7 shows the hydrogen peroxide consumption for each recycle of the delignification reactions of pretreated canola and untreated canola biomass as mass of H₂O₂/mass of starting biomass. Table 7 also shows the results of the characterization of the obtained cellulose. This was conducted to determine the efficiency of the pulping process and the amount of hemicellulose remaining in the cellulosic portion removed. For that purpose, TAPPI T203 method was followed to determine the amount of gamma-cellulose (or hemicellulose) in the solids.

TABLE 7
Hydrogen peroxide consumption of the delignification reactions as well as hemicellulose and
cellulose content in the cellulose solids obtained from the delignification of untreated
canola biomass and canola biomass pretreated according to the method described herein.

| | Pretreated canola | | | Untreated canola | | |
|---|---|---|---|---|---|---|
| | H₂O₂ | | | H₂O₂ | | |
| | consumption | Cellulose | Hemicellulose | consumption | Cellulose | Hemicellulose |
| Blend ID | (%) | (%) | (%) | (%) | (%) | (%) |
| Fresh blend | 0.0473 | 94.8 | 5.2 | 0.3864 | 91.3 | 8.7 |
| Recycle 1 | 0.1826 | 93.2 | 6.8 | 0.6259 | 91.7 | 8.3 |
| Recycle 2 | 0.5370 | 95.9 | 4.1 | 2.0882 | 89.4 | 10.6 |

The results in Table 7 show that the hemicellulose content in the recovered cellulose portion is consistently lower for the pretreated canola biomass than for the untreated canola. This is expected as most of the hemicellulose was extracted during the pretreatment. As the hemicellulose is known to be dissolved into the LHDO portion, more significant differences were to be expected in that portion than in the cellulose.

The results in Table 7 indicate that the peroxide consumption per gram of biomass decreases by more than 70% when the biomass has been pretreated to remove the hemicellulose component. This decrease is substantial and can lead to very favourable economic benefits.

### Post-Delignification Parameters

LHDO added to pre-weighed round bottom flask containing magnetic stir bar. The required mass of alcohol solvent was added in a 2:1 ratio of alcohol:LHDO by weight. The mixture was placed in an oil bath on a heating stir plate, and the bath temperature was set to 60° C. and the reaction was stirred for 16 hours. After 16 hours, the reaction mixture was removed from the oil bath, left to cool and then filtered through a medium fritted filter to remove precipitated solids. The solids were rinsed with additional alcohol, collected, dried overnight in a 45° C. oven, and then weighed. The filtrate was concentrated on a rotary evaporator and then transferred to a separatory funnel. Water and ethyl propionate were added, and the product was extracted into the organic phase. The organic phase was collected, and the aqueous phase was extracted two additional times with fresh ethyl propionate. The organic phases were combined and transferred back into the separatory funnel, where they were washed with two portions of a pH 2.5 sulfate buffer solution. The organic phase was then dried over MgSO₄, filtered into a round bottom flask, and evaporated on a rotary evaporator to remove all volatiles. The residue was then weighed and the yield calculated.

The evaporated portion containing all the volatiles was collected, weighed and titrated with base to determine the acetic acid content. Table 8 reports the yields of LHDO as % of the dissolved biomass, where dissolved biomass is calculated as the overall mass of biomass that was delignified minus the overall recovered cellulose, and yields of acetic acid as % of the esterified LHDO.

TABLE 8
Esterified LHDO and acetic acid yields from the delignification
reactions of untreated canola biomass and canola biomass
pretreated according to the method described herein.

| | Pretreated | Untreated |
|---|---|---|
| | canola | canola |
| Acetic Acid (g/g esterified LHDO) | 31 | 39 |
| Yield LHDO (g/g biomass dissolved) | 14.0 | 7.2 |

As observed in Table 8, the yields of esterified LHDO increase when the canola biomass is pretreated to remove the hemicellulose. This is due to the increase in lignin content of the starting biomass prior to delignification. The acetic acid yields decrease with the pretreatment as less hemicellulose is present in the biomass for delignification. It is known to those skilled in the art that laboratory scale experimentation may have larger errors due to the small volumes handled. It is also known that while the majority of acetic acid comes from the decomposition of hemicellulose (and other sugars), lignin also decomposes into acetic acid to a lesser extent; thus, potentially contributing to the acetic acid yield.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A method for removing the constituents of a biomass into separate streams, where said method comprises the following steps:
Step 1: providing a biomass feedstock comprising: cellulose; hemicellulose; and lignin;
Step 2: exposing said biomass to a first acidic composition comprising an acid selected from the group consisting of: mineral acids; organic acids; modified acids; synthetic acids; and combinations thereof; for a first period of time sufficient to dissolve at least 50% of the hemicellulose present in said biomass;
Step 3: separating and recovering into a first liquid stream, the dissolved hemicellulose from the remaining biomass;
Step 4: exposing the remaining biomass mixture to a modified Caro's acid selected from the group consisting of:
composition A; composition B and Composition C;
wherein said composition A comprises:
sulfuric acid in an amount ranging from 20 to 70 wt % of the total weight of the composition;
a compound comprising an amine moiety and a sulfonic acid moiety selected from the group consisting of: taurine; taurine derivatives;
and taurine-related compounds; and
a peroxide;
wherein said composition B comprises:
an alkylsulfonic acid; and
a peroxide; wherein the acid is present in an amount ranging from 40 to 80 wt % of the total weight of the composition and where the peroxide is present in an amount ranging from 10 to 40 wt % of the total weight of the composition;
wherein said composition C comprises:
sulfuric acid;
a compound comprising an amine moiety;
a compound comprising a sulfonic acid moiety; and
a peroxide;
for a first period of time sufficient to dissolve enough of the lignin present in said remaining biomass mixture to obtain a kappa number for the cellulose of less than 5;
Step 5: recovering into a second liquid stream the dissolved lignin from the resulting reaction mixture, wherein said solid portion comprises cellulose fibers with, at most, 10 wt % hemicellulose.

2. The method according to claim 1 wherein said first acidic composition comprises an acid selected from the group consisting of: H₂SO₄; HCl; methanesulfonic acid; toluenesulfonic acid; HCl:amino acid; and HCl:alkanolamine.

3. The method according to claim 1, wherein said first acidic composition is added to the biomass in a concentration ranging from 0.1 to 10% and the biomass mixture is heated to a temperature ranging from 50° C. to 150° C. for a period of time sufficient to remove at least 50% of the hemicellulose present in said biomass.

4. The method according to claim 3, wherein the period of time is sufficient to remove at least 60% of the hemicellulose present in said biomass.

5. The method according to claim 3, wherein the period of time is sufficient to remove at least 70% of the hemicellulose present in said biomass.

6. The method according to claim 3, wherein the period of time is sufficient to remove at least 80% of the hemicellulose present in said biomass.

7. The method according to claim 3, wherein the period of time is sufficient to remove at least 90% of the hemicellulose present in said biomass.

8. The method according to claim 1, wherein the lignin remaining after the delignification step is less than 2 wt. % of the solid portion.

9. The method according to claim 1, wherein the lignin remaining after the delignification step is less than 1 wt. % of the solid portion.

10. The method according to claim 2, wherein said first acidic composition is added to the biomass in a concentration ranging from 0.1 to 10% and the biomass mixture is heated to a temperature ranging from 50° C. to 150° C. for a period of time sufficient to remove at least 50% of the hemicellulose present in said biomass.

11. The method according to claim 2, wherein the lignin remaining after the delignification step is less than 2 wt. % of the solid portion.

12. The method according to claim 3, wherein the lignin remaining after the delignification step is less than 2 wt. % of the solid portion.
